(19) United States
(12) Patent Application Publication
(10) Pub. No.: US 2015/0058844 A1
(43) Pub. Date: Feb. 26, 2015

(54) VIRTUAL COMPUTING RESOURCE ORCHESTRATION

(71) Applicants: Thomas Eaton Conklin, Leesburg, VA (US); Vinay Saxena, Richardson, TX (US)

(72) Inventors: Thomas Eaton Conklin, Leesburg, VA (US); Vinay Saxena, Richardson, TX (US)

(73) Assignee: HEWLETT-PACKARD DEVELOPEMENT COMPANY, L.P., Houston, TX (US)

(21) Appl. No.: 14/378,430

(22) PCT Filed: Jul. 30, 2012
(86) PCT No.: PCT/US12/48772

§ 371 Date: Aug. 13, 2014

Related U.S. Application Data
(60) Provisional application No. 61/624,911, filed on Apr. 16, 2012.

(51) Int. Cl. G06F 9/455

(52) U.S. Cl. CPC G06F 9/45533
USPC 718/1

(57) ABSTRACT

According to an example, a method for virtual computing resource orchestration includes receiving environmental data related to an operational characteristic of a compute resource for hosting a virtual machine (VM), receiving VM data related to an operational characteristic of the VM, and determining if the environmental data or the VM data violate predetermined threshold values respectively related to the environmental data and the VM data. The method further includes generating an event based on violation of one of the threshold values by the environmental data or the VM data, evaluating, by a processor, a rule to determine an action based on the violation of one of the threshold values, and executing the action to modify the operational characteristic of the compute resource or the operational characteristic of the VM.

### BACKGROUND

In a virtual computing environment, large enterprises typically include resource allocations designed to meet worst-case scenarios. Aspects, such as the creation, migration and updating of virtual machines (VMs) are typically performed based on limited information. For example, a number of VMs allocated for executing an application is typically based on the computing demands of the application. As the computing demand increases, the number of VMs allocated for the application is likewise increased. However, such techniques for allocation of VM resources can be inefficient.

### BRIEF DESCRIPTION OF DRAWINGS

Features of the present disclosure are illustrated by way of example and not limited in the following figure(s), in which like numerals indicate like elements, in which:

FIG. 1 illustrates an architecture of a virtual computing resource orchestration apparatus, according to an example of the present disclosure;

FIG. 2 illustrates an example of power input for the virtual computing resource orchestration apparatus, according to an example of the present disclosure;

FIG. 3 illustrates an example of a hardware setup for the virtual computing resource orchestration apparatus, according to an example of the present disclosure;

FIG. 4 illustrates an example of an application for the hardware setup of FIG. 3 for the virtual computing resource orchestration apparatus, according to an example of the present disclosure;

FIG. 5 illustrates another example of an application for the hardware setup of FIG. 3 for the virtual computing resource orchestration apparatus, according to an example of the present disclosure;

FIG. 6 illustrates another example of an application for the hardware setup of FIG. 3 for the virtual computing resource orchestration apparatus, according to an example of the present disclosure;

FIG. 7 illustrates an example of a physical network for the virtual computing resource orchestration apparatus, according to an example of the present disclosure;

FIG. 8 illustrates an example of an application for the physical network of FIG. 7 for the virtual computing resource orchestration apparatus, according to an example of the present disclosure;

FIG. 9 illustrates an example of an application for the physical network of FIG. 7 for the virtual computing resource orchestration apparatus, according to an example of the present disclosure;

FIG. 10 illustrates an example of an application for the physical network of FIG. 7 for the virtual computing resource orchestration apparatus, according to an example of the present disclosure;

FIG. 11 illustrates an example of an application for the physical network of FIG. 7 for the virtual computing resource orchestration apparatus, according to an example of the present disclosure;

FIG. 12 illustrates a method for virtual computing resource orchestration, according to an example of the present disclosure: and

FIG. 13 illustrates a computer system, according to an example of the present disclosure.

### DETAILED DESCRIPTION

For simplicity and illustrative purposes, the present disclosure is described by referring mainly to examples. In the following description, numerous specific details are set forth in order to provide a thorough understanding of the present disclosure. It will be readily apparent however, that the present disclosure may be practiced without limitation to these specific details. In other instances, some methods and structures have not been described in detail so as not to unnecessarily obscure the present disclosure.

Throughout the present disclosure, the terms “a” and “an” are intended to denote at least one of a particular element. As used herein, the term “includes” means includes but not limited to, the term “including” means including but not limited to. The term “based on” means based at least in part on.

In a virtual computing environment, a variety of factors can impact the overall operational characteristics of an enterprise that subscribes to or provides resources for the virtual computing environment. For example, a virtual computing environment can include a variety of virtual machines, servers, and other compute resources that are needed, for example, to execute applications. The servers and other such components can have environmental resource needs, such as, power consumption, thermal utilization, etc., that can vary. For example, power consumption can vary based on the load on a server, and based on other factors such as the temperature of the server environment. Also, the cost for power can vary, for example, based on the time of day, location, the load on a server or other resources. The overall operational characteristics of an enterprise can also be impacted by factors such as the number and type of VM resources, the traffic at any given time, and the type of VM and other network resources.

According to an example, a virtual computing resource orchestration apparatus and method are described. The virtual computing resource orchestration apparatus and method provide for data to be collected, for example, by input or by polling. The data may be collected, for example, based on whether the virtual computing resource orchestration apparatus and method can control services that are affected by the data. The collected data may be used in conjunction with physical and logical inventory of the virtual computing resource orchestration apparatus, for example, to make decisions to add elasticity to compute elements controlled by the virtual computing resource orchestration apparatus and method. For example, the decisions may include adding and/or removing physical compute resources, and adding, removing and/or migrating virtual compute elements resources. The virtual computing resource orchestration apparatus and method provide for control of a distributed computing environment, for example, by distributing resources, to maximize efficiency of resource utilization.

According to an example, the virtual computing resource orchestration apparatus includes a memory storing a module comprising machine readable instructions to receive environmental data related to an operational characteristic of a compute resource for hosting a VM, and receive VM data related to an operational characteristic of the VM. The module further comprises machine readable instructions to determine if the environmental data or the VM data violate predetermined threshold values respectively related to the environmental data and the VM data, generate an event based on violation of one of the threshold values by the environmental data or the VM data, and evaluate a rule to determine an action based on the violation of one of the threshold values. The virtual computing resource orchestration apparatus further includes a processor to implement the module.

According to another example, the method for virtual computing resource orchestration includes receiving environmental data related to an operational characteristic of a compute resource for hosting a VM, receiving VM data related to an operational characteristic of the VM, and determining if the environmental data or the VM data violate predetermined threshold values respectively related to the environmental data and the VM data. The method further includes generating an event based on violation of one of the threshold values by the environmental data or the VM data, evaluating, by a processor, a rule to determine an action based on the violation of one of the threshold values, and executing the action to modify the operational characteristic of the compute resource or the operational characteristic of the VM.

According to another example, a non-transitory computer readable medium having stored thereon machine readable instructions for virtual computing resource orchestration is also described. The machine readable instructions when executed cause a computer system to receive environmental data related to an operational characteristic of a compute resource for hosting a VM, receive VM data related to an operational characteristic of the VM, and determine if the environmental data or the VM data violate predetermined threshold values respectively related to the environmental data and the VM data. The machine readable instructions when executed further cause the computer system to generate an event based on a plurality of violations of one of the threshold values by the environmental data or the VM data, and evaluate, by a processor, a rule to determine an action based on the plurality of violations of one of the threshold values.

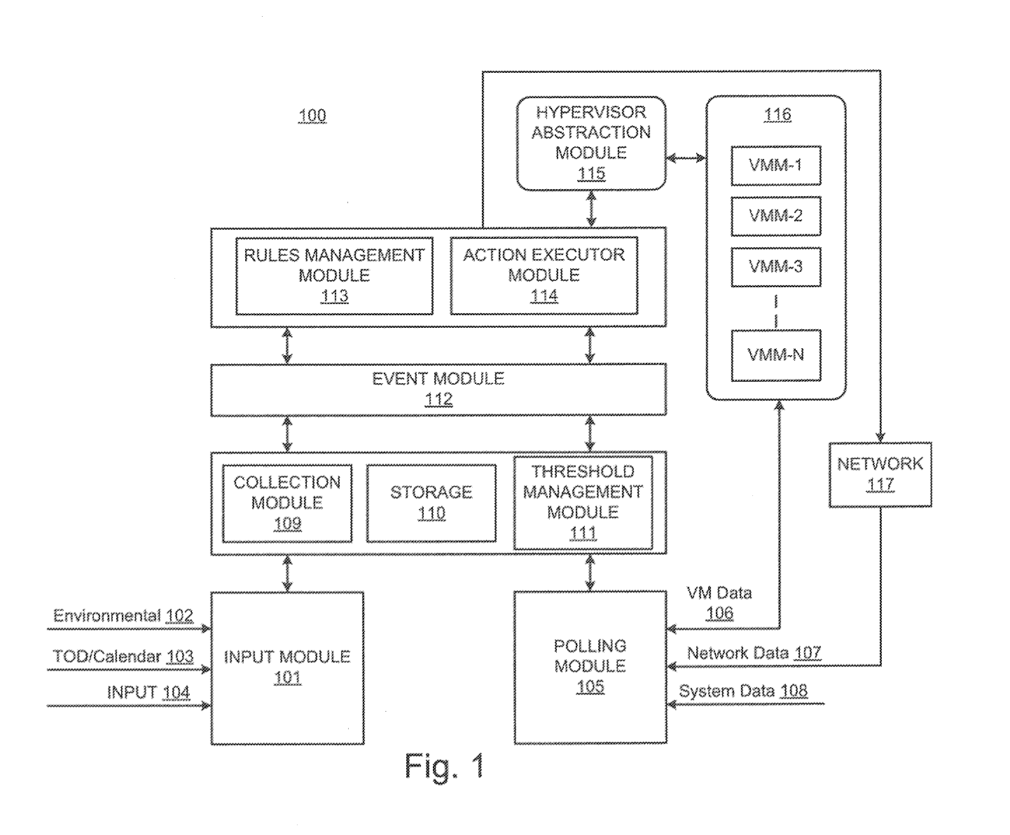

FIG. 1 illustrates an architecture of a virtual computing resource orchestration apparatus 100, according to an example. Referring to FIG. 1, the apparatus 100 is depicted as including an input module 101 to receive environmental data 102 and corresponding time of day (TOD) and calendar information 103. The input module 101 is to receive further input data at 104, for example, related to configuration of the virtual computing resource orchestration apparatus 100 and various other components of the apparatus 100, by a user of the apparatus 100. A polling module 105 is to poll various resources to receive virtual machine (VM) data 106, network data 107 and system data 108. The data obtained by the input module 101 and the polling module 105 may be collected by a collection module 109 and stored by storage 110. A threshold management module 111 is to manage threshold values for further analysis of the data from the storage 110, and determine whether a threshold is violated. An event module 112 is to generate events, for example, based on analysis of aggregated data against the threshold values managed by the threshold management module 111. A rules management module 113 is to manage rules and make decisions on actions, such as increasing or decreasing VM allocation for a datacenter. An action executor module 114 is to execute an action event, for example, from an available set of action events, based on the determination made by the rules management module 113. A hypervisor abstraction module 115 is to provide an interface between the action event executed by the action executor module 114 and various virtualization systems 116, which may be provided by various datacenters provided at different geographic locations. The virtualization systems 116 may include, for example, different hypervisor systems including virtual machine managers (VMMs) 1-N that implement different VM resources. The network data 107 may be obtained from a network 117, which is also monitored and controlled by the virtual computing resource orchestration apparatus 100. The system data 108 may be obtained from computer systems and other such resources, and include data, such as, central processing unit (CPU) usage, memory usage, transmission control protocol (TCP) connections, etc.

The collection module 109, the storage 110 and the threshold management module 111 may be generally provided in a data collection layer of the virtual computing resource orchestration apparatus 100. The data collection layer is to generally collect data regarding traffic over a network. The event module 112 may be generally provided in an event layer of the virtual computing resource orchestration apparatus 100. The event layer is to generally determine whether an action for compute elements in the network based upon the collected data is to be performed. The rules management module 113 and the action executor module 114 may be generally provided in an action layer of the virtual computing resource orchestration apparatus 100. The action layer is to generally execute the determined action.

The modules 101, 105, 109, and 111-115, and other components of the apparatus 100 that perform various other functions in the apparatus 100, may comprise machine readable instructions stored on a computer readable medium. In addition, or alternatively, the modules 101, 105, 109, and 111-115, and other components of the apparatus 100 may comprise hardware or a combination of machine readable instructions and hardware.

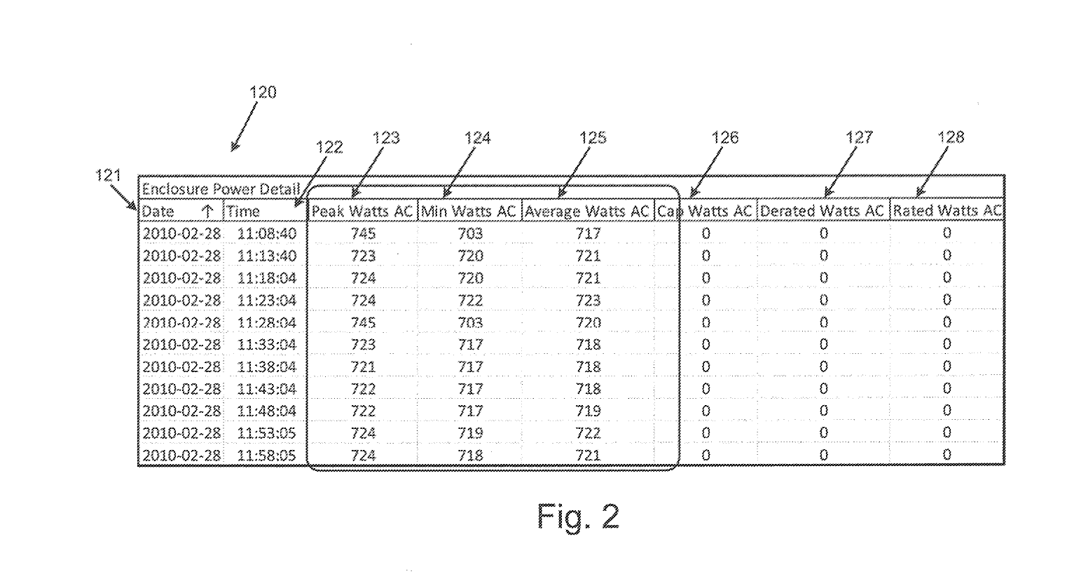

Referring to FIG. 1, the input module 101 is to receive environmental data 102 and corresponding TOD and calendar information 103. The input module 101 is to receive further input data at 104 by a user of the virtual computing resource orchestration apparatus 100. For example, for the environmental data 102, power and thermal utilization data (e.g., cooling data) may be collected from a server chassis via simple network management protocol (SNMP). Referring to FIG. 2, an example of the environmental data 102 may include enclosure power detail data 120 for a server hosting VM resources. The enclosure power detail data 120 may include date and time information at 121 and 122, respectively, which may be received by the input module 101 as the corresponding TOD and calendar information 103. The enclosure power detail data 120 may further include, for example, peak watts alternating current (AC) at 123, minimum watts AC at 124, average watts AC at 125, cap watts AC at 126, derated watts AC at 127 and rated watts AC at 128. For the input module 101, the environmental data 102 and/or input data at 104 may also include data related to, for example, power utilization, power cost, external rack temperature, network resources, TOD events that have a bearing on how VMs can be moved, migrated and/or stopped. The input data at 104 may also include rules that are defined for specific actions that are to be taken based on the type of data that is received, for example, by the input module 101 or instead by the polling module 105. The rules that are defined based on specific actions may include rules directed to, for example, starting, stopping, cloning and/or migrating VMs. The environmental data 102 and TOD and calendar information 103 may be related to components of the virtualization systems 116 and the network 117.

The polling module 105 is to poll various resources to receive VM data 106, network data 107 and system data 108. The polling module 105 may collect data via SNMP for physical and virtual systems. The VM data 106 may include data collected, for example, from hypervisor managers on the state of VMs. For example, the VM data 106 may include a number of VMs managed by the various virtualization systems 116. The VM data 106 may also include the capacity of VMs managed by the various virtualization systems 116. The polling module 105 may collect network data 107 such as traffic on a given interface and other aspects related to network utilization, and system data 108, such as, CPU usage, memory usage, TCP connections, and swap utilization, etc.

The threshold management module 111 is to manage threshold values for further analysis of the data from the storage 110, and determine when a threshold is violated. For example, once data is collected by the input module 101 and the polling module 105, the data is collected by the collection module 109 and stored by storage 110. The stored data may be checked against individual threshold values by the threshold management module 111 to determine when a threshold is violated. For example, a threshold may be based on low (e.g., 30%) and high (e.g., 80%) watermarks for memory consumption. If memory consumption is lower or higher than the low and high watermarks, respectively, then the threshold management module 111 indicates a threshold violation to the event module 112.

The event module 112 is to generate events, for example, based on analysis of aggregated data against the threshold values managed by the threshold management module 111. The events may be generated, for example, based on an evaluation of aggregated data within a predetermined time period. The event module 112 may evaluate aggregated data from various sources and multiple triggers to generate events, for example, related to increased CPU utilization, network utilization and a maximum number of VMs that can be supported on a given server. For example, the event module 112 may receive one or more threshold violations from the threshold management module 111, and based on an evaluation of the aggregated data and the threshold violations, the event module 112 may generate an event indicating increased CPU utilization.

As an example, the event module 112 may receive one or more threshold violations related to power usage and one or more threshold violations related to power rate from the threshold management module 111. For example, the threshold violations related to power usage may indicate power usage for compute resources of the virtualization systems 116 exceeding a predetermined threshold. Likewise, the threshold violations related to power rate may indicate a lower power rate between the hours of 12:00 pm-3:00 pm on the west coast of the United States compared to the east coast. Based on this data related to power usage and power rate, the event module 112 may generates events indicating increased power usage and decreased power rate at the west coast. The events may be analyzed by the rules management module 113 as described below, for example, to migrate VM resources of the virtualization systems 116 from the east coast to the west coast for a predetermined time period, or to forego migration of the VM resources if the cost of the migration outweighs the benefits. Alternatively, the events may be analyzed by the rules management module 113 to add additional VM resources to a datacenter on the east coast to reduce the burden on existing VM resources to thus manage power usage.

The rules management module 113 is to manage rules and make decisions on actions, such as increasing or decreasing VM allocation for a datacenter. Rules may be generally defined as parameters around which the virtual computing resource orchestration apparatus 100 governs a service provided by the various virtualization systems 116. Generally, the rules management module 113 receives event data (i.e., events) from the event module 112 and compares the event data to pre-configured rules to determine if an action is to be taken. The rules may be defined, for example, using an extensible markup language (XML) file. A rule may be associated with its run-time execution class (e.g., environmental based rule, or network based rule) and loaded dynamically into the rules management module 113. Rules may also be pre-configured or defined in the rules management module 113. Rules may be defined, for example, by analytical data processing of past data and/or trends on the data collected by the input module 101 and the polling module 105. Rules may also be defined based on types of events. For example, rules may be defined to take affect based on high profile events. For example, a rule may be based on a high profile event such as a death of an artist, where such an event may lead to an increase in traffic and thus increased VM allocation for a datacenter. Rules may also be defined based on capacity of components. For example, a number of VMs that are allowed to run on a particular server may be determined based on the type of server. The number of VMs that are allowed to run on a type of server may also be determined based on historic testing and data.

With regard to the rules management module 113, the rules may be set to add, remove and/or migrate VM resources to optimize an operational characteristic of the service delivery environment provided by the virtualization systems 116. For example, rules may cause various VM resources of the virtualization systems 116 to be implemented in different servers to substantially minimize the amount of power consumed by different servers for implementing the VM resources. In another example, rules may cause the various VM resources of the virtualization systems 116 to be implemented in different servers to substantially maximize efficiency of implementing the VM resources. For example, the rules management module 113 may include rules that cause various workloads to be completed as efficiently as possible. The rules may also be defined by users and input into the rules management module 113 via the input 104 of the input module 101.

As discussed above, the rules management module 113 manages rules that may be set to add, remove and/or migrate VM resources to optimize an operational characteristic of the service delivery environment provided by the virtualization systems 116. As an example, a rule may provide for a predetermined number of VMs (e.g., 200) on a server, a predetermined percentage of memory utilization (e.g., 80%), and a predetermined power usage (e.g., 60 kW). Violation of a threshold, for example, for predetermined power usage, may be detected by the threshold management module 111, and the event module 112 generates events indicating violation of the thresholds. The events generated by the event module 112 are received by the rules management module 113 and compared to pre-configured rules to determine if an action is to be taken. The pre-configured rules may be based on increasing or decreasing VM allocation for a datacenter for violation of the thresholds. For example, if a threshold violation indicates 70 kW power usage for a predetermined time period or multiple such threshold violations are detected, a rule may provide for an increase in the number of VMs allocated for a datacenter. Alternatively, if a threshold violation indicates 40 kW power usage for a predetermined time period, a rule may provide for a decrease in the number of VMs allocated for a datacenter, compared to the allocation of 200 VMs on a server. Further, if a threshold violation indicates 40 kW power usage for less than a predetermined time period, or a number of threshold violations within a predetermined time period is less than a predetermined number of minimum threshold violations needed by the event module 112, the event module 112 may forego generation of an event, or if an event is generated, a rule may provide for no modification to the number of VMs allocated for a datacenter.

The action executor module 114 is to execute an action event, for example, from an available set of action events, based on the determination made by the rules management module 113. For example, if the rules management module 113 determines an action to be taken, based on a configuration of the virtual computing resource orchestration apparatus 100 and/or available resources for the virtualization systems 116, the action executor module 114 executes an action event.

The hypervisor abstraction module 115 is to provide an interface between an action event executed by the action executor module 114 and the various VM resources of the virtualization systems 116, which may be provided by various datacenters provided at different geographic locations. The hypervisor abstraction module 115 may use physical and/or logical resources to determine where and how to execute an action event executed by the action executor module 114. Based on a determination by the hypervisor abstraction module 115, the module 115 provides the interface for execution of the action event, for example, to add, delete, and/or migrate the various VM resources of the virtualization systems 116. Further, based on a determination by the hypervisor abstraction module 115 of lack of VM resources of the virtualization systems 116, the hypervisor abstraction module 115 may inquire with an inventory of spare compute resources and thereby add, delete, and/or migrate compute resources between the inventory of spare compute resources and the various VM resources of the virtualization systems 116.

As discussed above, the various VM resources of the virtualization systems 116 may be provided by various datacenters provided at different geographic locations. The environment of the virtual computing resource orchestration apparatus 100 may include multiple datacenters located in the same or different geographic locations. For example, a datacenter may be located in the United States and another datacenter may be located in Europe. The VM resources of the virtualization systems 116 may be added to one or more datacenters and/or migrated from one datacenter to another. Further, decisions to add and/or migrate the VM resources of the virtualization systems 116 may be based upon factors, such as, the locations, current time, etc., of the datacenters.

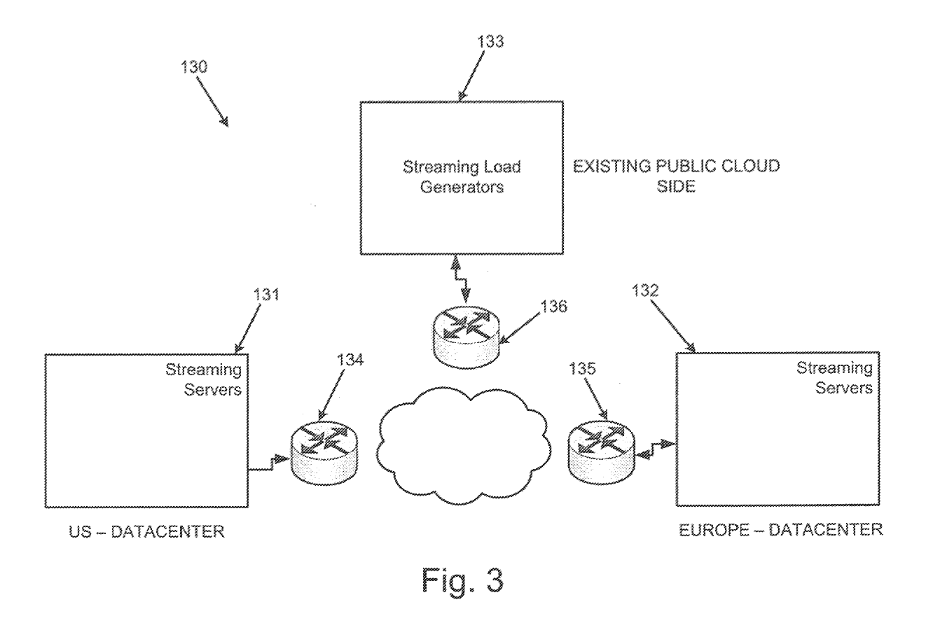

Referring to FIG. 3, an example of a hardware setup 130 for the virtual computing resource orchestration apparatus 100 is described. The hardware setup 130 may generally include datacenters 131 and 132. For example, the datacenter 131 may be a datacenter in the United Sates (U.S.) and the datacenter 132 may be a datacenter in Europe. A cloud provider 133 may provide additional compute resources to the datacenters 131 and 132 by routers 134-136 based on additional needed capacity.

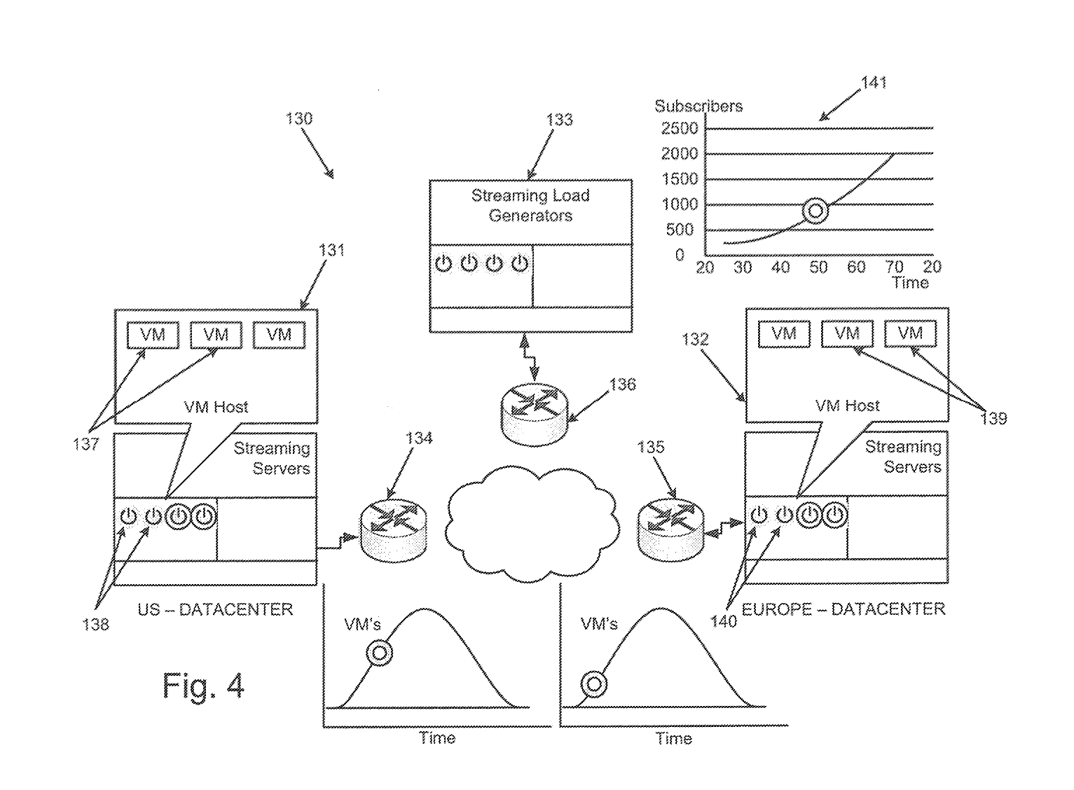

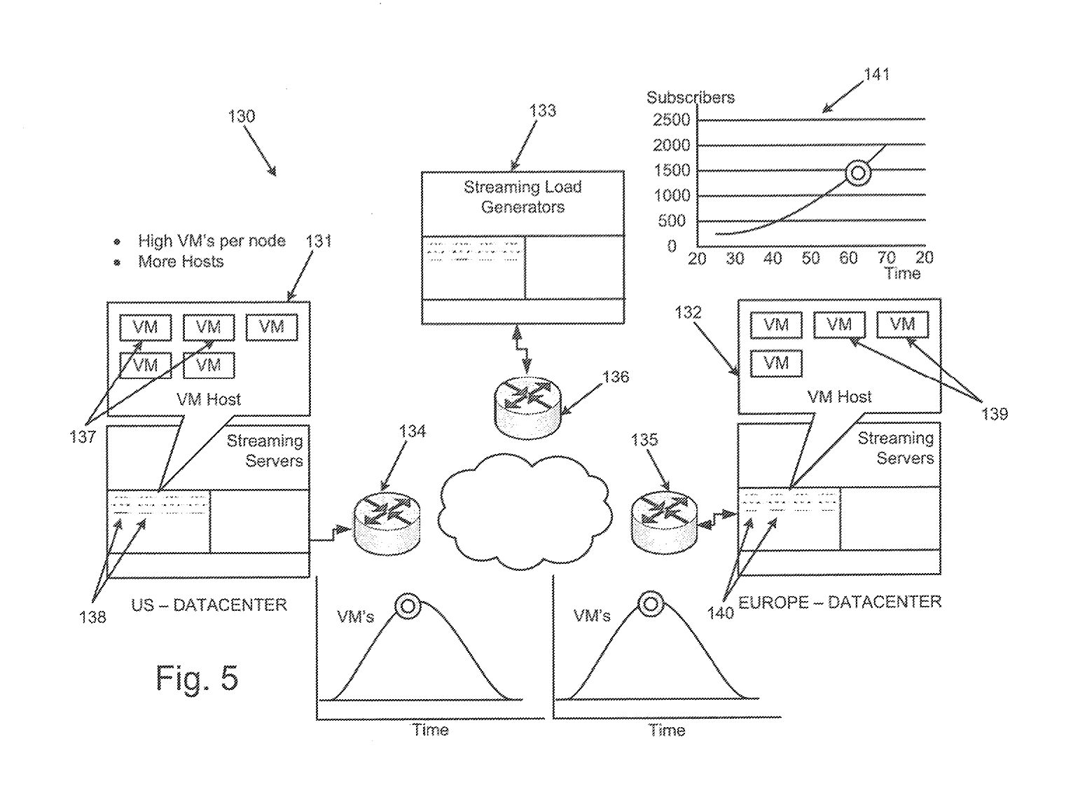

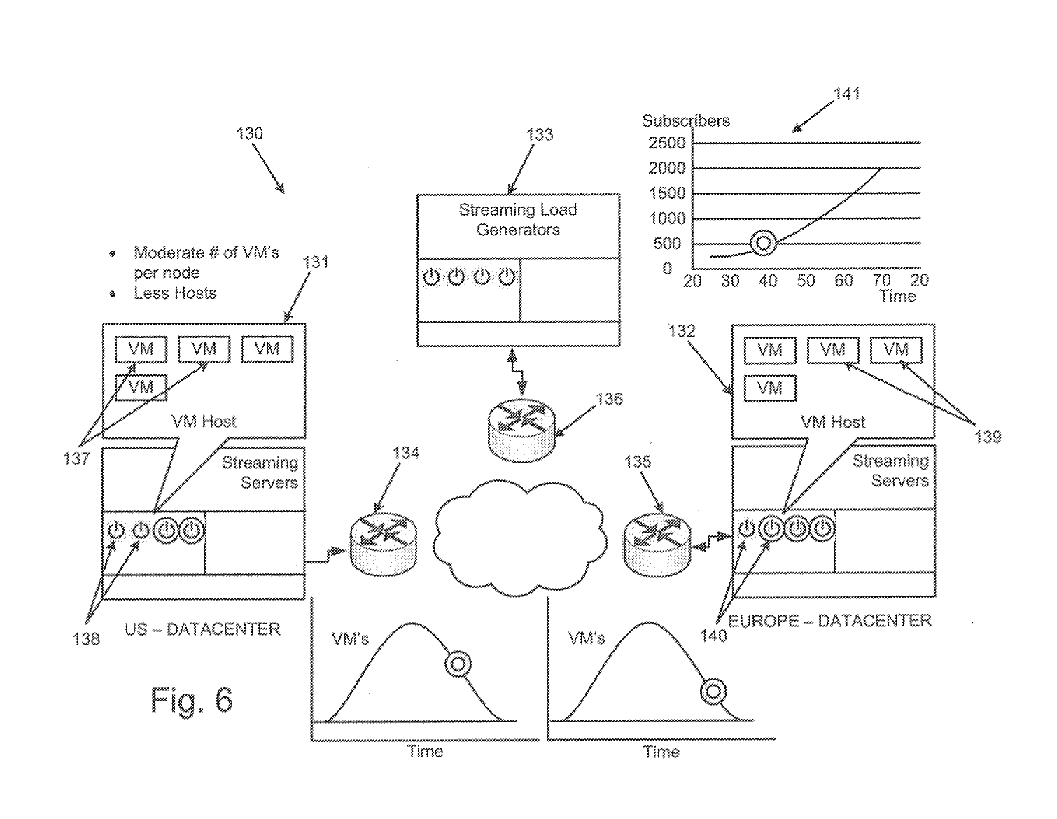

Referring to FIG. 4, at an initial state t0 (i.e., at time t=0) each of the datacenters 131 and 132 may include a load based on the active VMs. For example the U.S. based data center 131 may include active VMs 137, and power switches 138 that may be activated as needed. Similarly, the Europe based data center 132 may include active VMs 139, and power switches 140. For FIG. 4, the U.S. based data center 131 is shown as including three VMs 137 and the Europe based data center 132 is shown as including three VMs 139. As the load on the datacenters 131 and 132 increases as shown by the load curve at 141, the number of active VMs per datacenter is also increased. For example, referring to FIG. 5, as the load on the datacenters 131 and 132 increases as shown by the load curve at 141, the U.S. based data center 131 is shown as including five VMs 137 and the Europe based data center 132 is shown as including four VMs 139. In this case, the input module 101 receives environmental data 102 corresponding to the load (e.g., power usage) on the datacenters 131 and 132, and associated TOD and calendar information 103. The polling module 105 further polls various resources to receive VM data 106, network data 107 and system data 108. Based on violation of thresholds related, for example, to power usage of various components of the datacenters 131 and 132, memory consumption related to VMs, etc., the threshold management module 111 indicates threshold violations to the event module 112. The event module 112 generates events, for example, related to the threshold violations, assuming the number of threshold violations meet thresholds related to a minimum number of threshold violations or predetermined time period for threshold violations. These events are analyzed by the rules management module 113 to make decisions on actions, such as increasing or decreasing VM allocation to the datacenters 131 and 132. Based on the determination by the rules management module 113, the action executor module 114 executes an action event, for example, to increase the number of active VMs for the datacenters 131 and 132 as shown in FIG. 5. Further, referring to FIG. 6, in a similar manner, as the load on the datacenters 131 and 132 decreases as shown by the load curve at 141, the U.S. based data center 131 is shown as including a reduced number of VMs (i.e., four VMs 137) and the Europe based data center 132 is also shown as including a reduced number of VMs (i.e., four VMs 139).

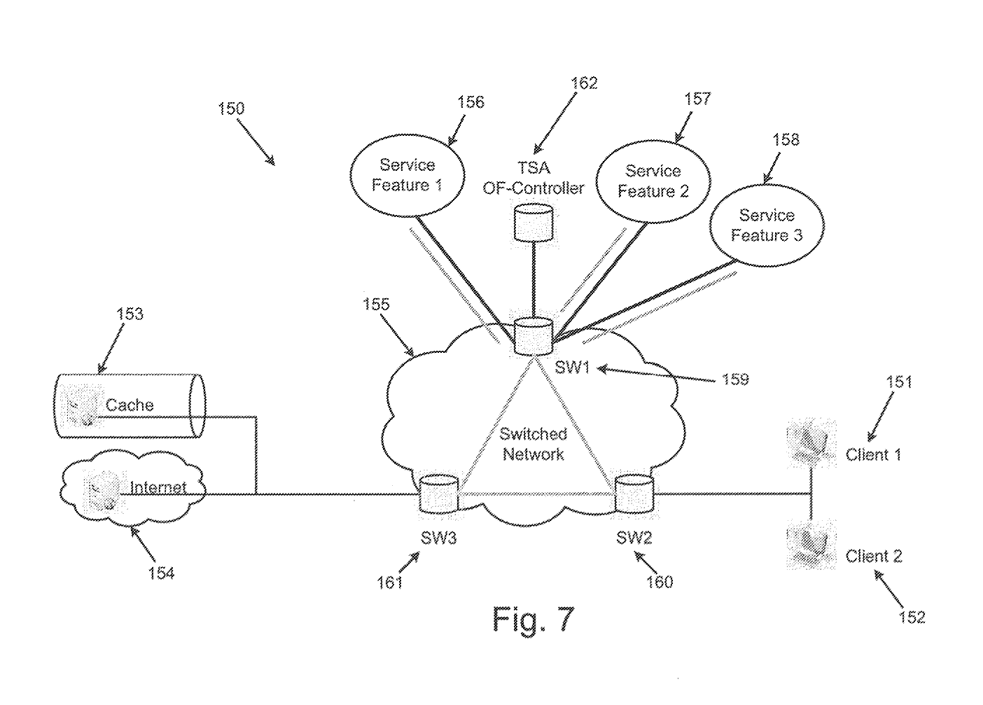

Referring to FIG. 7, another example of a hardware setup 150 for the virtual computing resource orchestration apparatus 100 is described. The hardware setup 150 may generally include client-1 at 151 and client-2 at 152 that are to send or receive data to a cache 153 or the Internet 154 via a service provider 155. The service provider 155 may generally include a plurality of service features to determine rights of the client-1 and the client-2 to send or receive data to the cache 153 or the Internet 154 via the service provider 155. For example, the service provider 155, shown as a cloud, may include a service feature-1 at 156 to determine if the client-1 and the client-2 have rights to access the service provider 155. The service feature-2 at 157 may determine the scope of the rights by the client-1 and the client-2. Further, the service feature-3 at 158 may determine billing related issues for the client-1 and the client-2. The service features 1-3 may be accessed by a switch-1 (SW1) at 159, and the flow of traffic from switches 1-3 (i.e., switch-1 (SW1) at 159, switch-2 (SW2) at 160 and switch-3 (SW3) at 161) may be controlled by a traffic steering application and OpenFlow controller (TSA OF-controller) 162. The service provider 155 may provide the services to the client-1 and the client-2 by a switched network including switches 1-3 as shown. The switched network may be the network 117 of FIG. 1, which is monitored and controlled by the virtual computing resource orchestration apparatus 100.

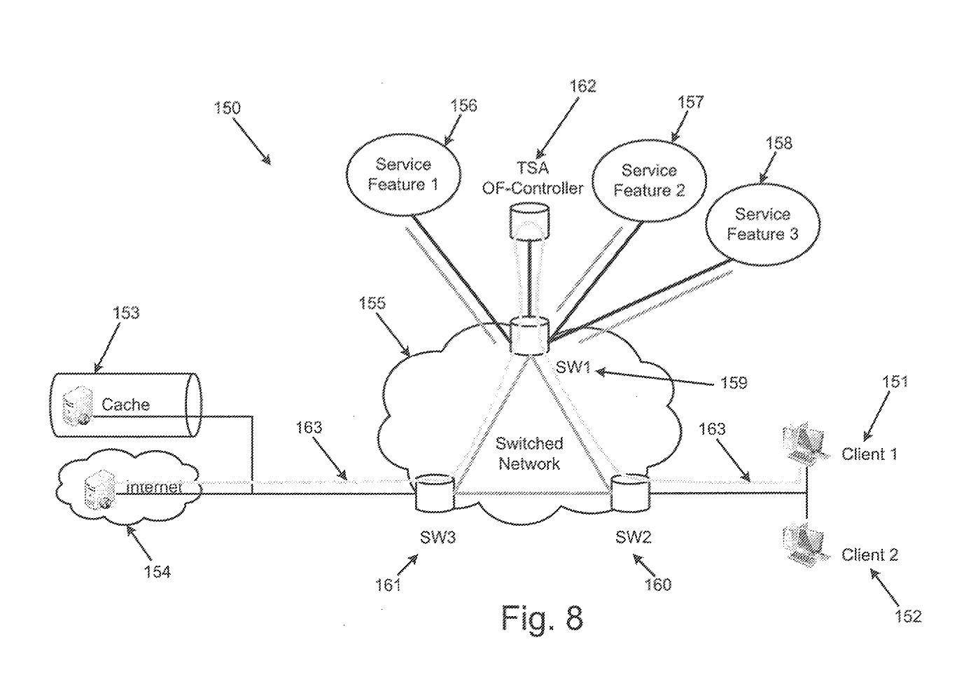

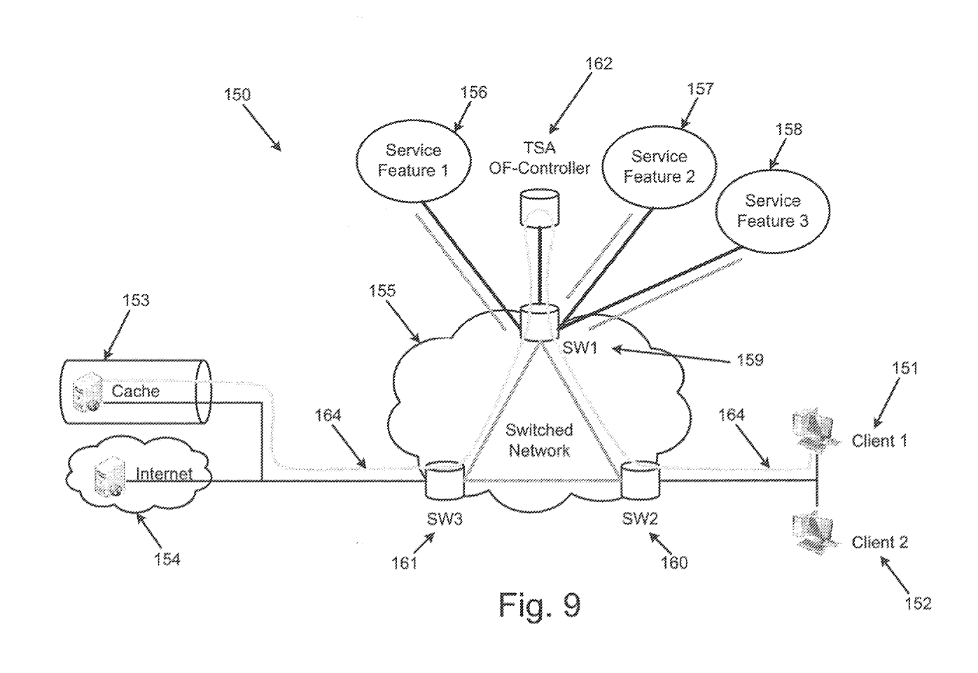

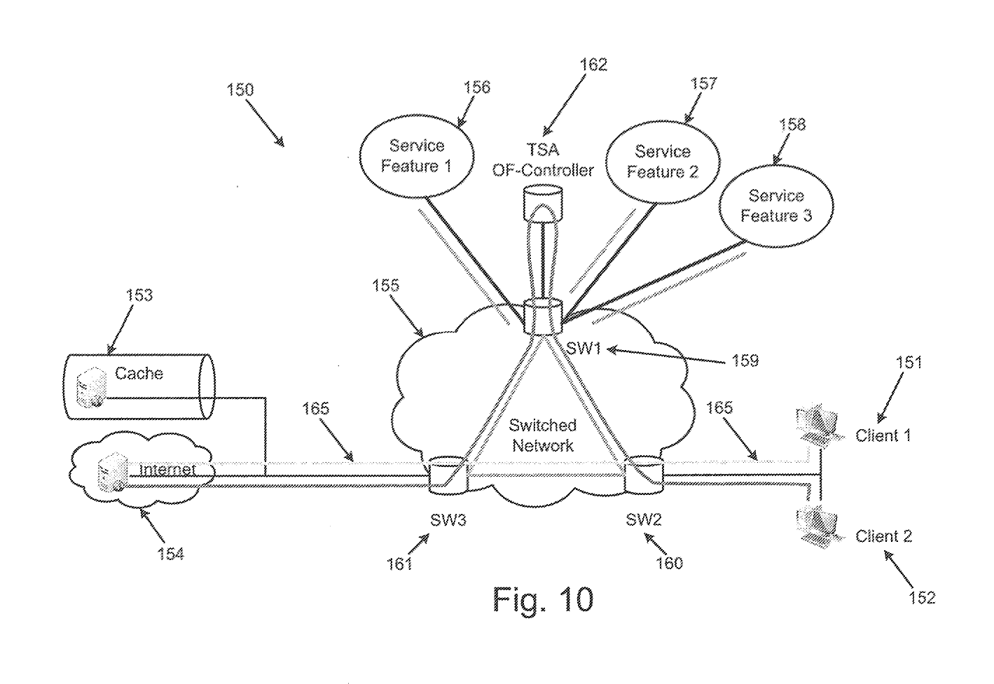

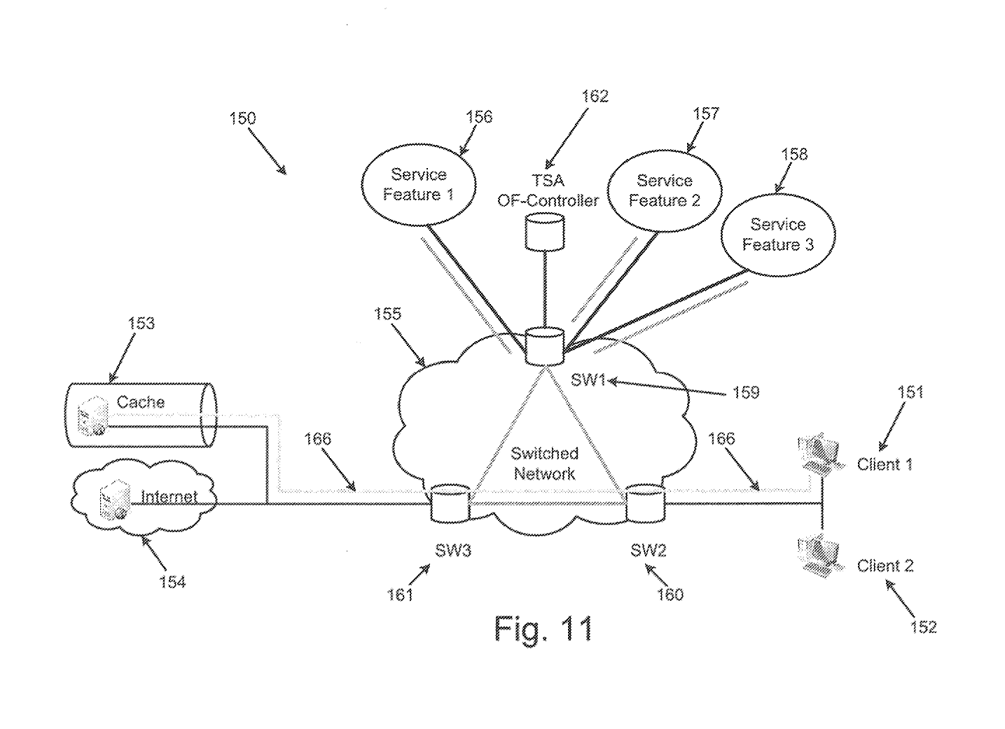

Referring to FIG. 8, for the hardware setup 150, the client-1 forwards a request to send or receive data from the Internet 154. Before flow identification, a flow from the client-1 to the Internet 154 is shown at various points at 163. Specifically, the flow 163 traverses from client-1 to switch-2, from switch-2 to switch-1, from switch-1 to TSA 162, from TSA 162 back to switch-1, from switch-1 to switch-3, and from switch-3 to the Internet 154. Similarly, at FIG. 9, the client-1 forwards a request to send or receive data from the cache 153. Before flow identification, a flow from the client-1 to the cache 153 is shown at 164. Specifically, the flow 164 traverses from client-1 to switch-2, from switch-2 to switch-1, from switch-1 to TSA 162, from TSA 162 back to switch-1, from switch-1 to switch-3, and from switch-3 to the cache 153. Referring to FIGS. 10 and 11, once the flows 163 and 164 from the client-1 to the Internet 154 or the cache 153 are identified, the flows may bypass switch-1 and the TSA 162, and directly traverse switches-2 and 3. For example, a flow from the client-1 to the Internet 154 is shown at 165. Specifically, the flow 165 traverses from client-1 to switch-2, from switch-2 to switch-3, and from switch-3 to the Internet 154. Similarly, a flow from the client-1 to the cache 153 is shown at 166. Specifically, the flow 166 traverses from client-1 to switch-2, from switch-2 to switch-3, and from switch-3 to the cache 153.

For the example of the hardware setup 150 of FIGS. 7-11, the service features 1-3 and other service features may include banks of compute resources that perform the requested services. For example, referring to FIG. 1, the service features may be provided by the compute resources of the virtualization systems 116, which may be provided by various datacenters provided at different geographic locations. As the number of consumers (e.g., client-1, client-2, etc.,) increases or decreases, based on load, the number of compute resources for the virtualization systems 116 is also increased or decreased accordingly by the virtual computing resource orchestration apparatus 100. The determination of whether to increase or decrease the compute resources for the virtualization systems 116 may also be based on a determination of whether service features are to be repeatedly accessed or accessed at an initial stage of communication. For example, for the hardware setup 150 of FIGS. 7-11, the service features 1-3 are bypassed after initial confirmation of the services available to the clients-1 and 2, and therefore, the compute resources for the virtualization systems 116 may not need to be increased based on an increase in initial traffic seen, for example, at network data 107, by the polling module 105. Further, thresholds related to the number of communications or duration of initial confirmation of the service features 1-3 may be set by the threshold management module 111. Once these thresholds are violated, any further communication from the clients-1 and 2 may be re-evaluated, for example, based on rules managed by the rules management module 113 to determine whether the compute resources for the virtualization systems 116 are to be increased, decreased or otherwise modified.

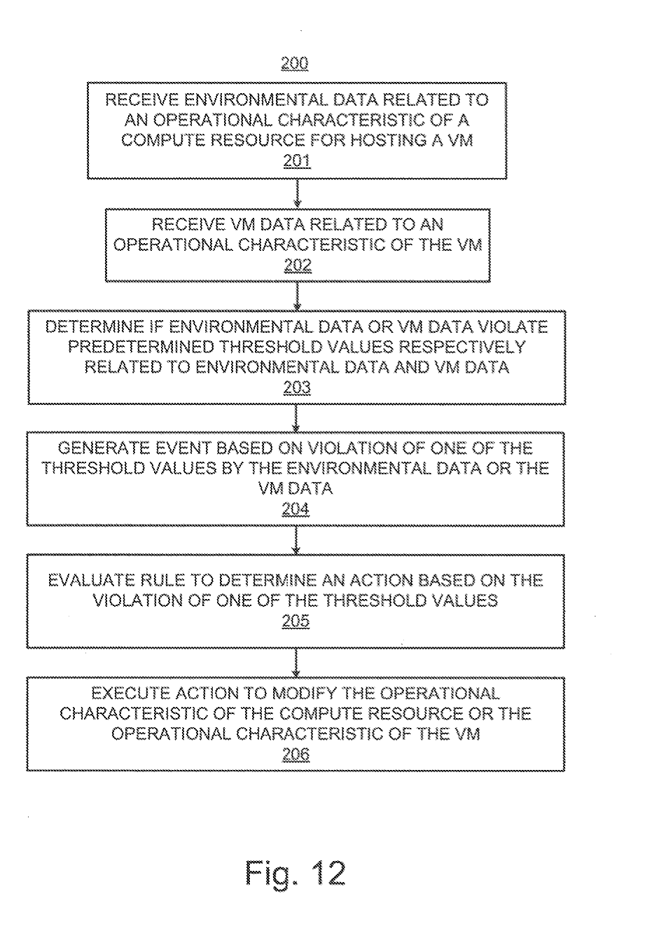

FIG. 12 illustrates a flowchart of a method 200 for virtual computing resource orchestration, corresponding to the example of the virtual computing resource orchestration apparatus 100 whose construction is described in detail above. The method 200 may be implemented on the virtual computing resource orchestration apparatus 100 with reference to FIG. 1 by way of example and not limitation. The method 200 may be practiced in other apparatus.

Referring to FIG. 12, for the method 200, at block 201, environmental data related to an operational characteristic of a compute resource for hosting a VM is received. For example, referring to FIG. 1, the input module 101 receives environmental data 102 and corresponding TOD and calendar information 103. The environmental data may include power usage of the compute resource for hosting the VM. Further, receiving VM data may include polling a virtualization system to obtain the VM data. The VM data may include a state or an operational capacity of the VM.

At block 202, VM data related to an operational characteristic of the VM is received. For example, referring to FIG. 1, the polling module 105 polls various resources to receive VM data 106, network data 107 and system data 108.

At block 203, a determination is made whether the environmental data or the VM data violate predetermined threshold values respectively related to the environmental data and the VM data. For example, referring to FIG. 1, the threshold management module 111 manages threshold values for further analysis of the data from the storage 110, and determines whether a threshold is violated.

At block 204, an event based on violation of one of the threshold values by the environmental data or the VM data is generated. For example, referring to FIG. 1, the event module 112 generates events, for example, based on analysis of aggregated data against the threshold values managed by the threshold management module 111. Generating an event may include generating the event based on a plurality of violations of one of the threshold values by the environmental data or the VM data. Alternatively, generating an event may include generating the event based on a predetermined number of a plurality of violations of one of the threshold values by the environmental data or the VM data. Further, alternatively, generating an event may include generating the event based on an evaluation of the environmental data and the VM data within a predetermined time period, and a plurality of violations of one of the threshold values by the environmental data or the VM data within the predetermined time period.

At block 205, a rule is evaluated to determine an action based on the violation of one of the threshold values. For example, referring to FIG. 1, the rules management module 113 manages rules and makes decisions on actions, such as increasing or decreasing VM allocation for a datacenter.

At block 206, the action to modify the operational characteristic of the compute resource or the operational characteristic of the VM is executed. For example, referring to FIG. 1, the action executor module 114 executes an action event, for example, from an available set of action events, based on the determination made by the rules management module 113. Further, the hypervisor abstraction module 115 provides an interface between the action event executed by the action executor module 114 and various virtualization systems 116, which may be provided by various datacenters provided at different geographic locations. Executing the action to modify the operational characteristic of the compute resource may include distributing a load on the compute resource between other compute resources. Executing the action to modify the operational characteristic of the VM may also include starting, stopping, adding, or removing a VM.

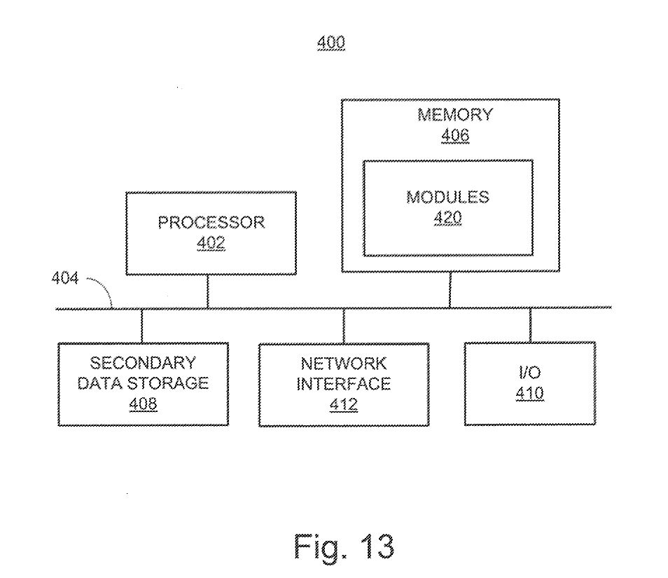

FIG. 13 shows a computer system 400 that may be used with the examples described herein. The computer system represents a generic platform that includes components that may be in a server or another computer system. The computer system may be used as a platform for the apparatus 100. The computer system may execute, by a processor or other hardware processing circuit, the methods, functions and other processes described herein. These methods, functions and other processes may be embodied as machine readable instructions stored on a computer readable medium, which may be non-transitory, such as hardware storage devices (e.g., RAM (random access memory), ROM (read only memory), EPROM (erasable, programmable ROM), EEPROM (electrically erasable, programmable ROM), hard drives, and flash memory).

The computer system includes a processor 402 that may implement or execute machine readable instructions performing some or all of the methods, functions and other processes described herein. Commands and data from the processor 402 are communicated over a communication bus 404. The computer system also includes a main memory 406, such as a random access memory (RAM), where the machine readable instructions and data for the processor 402 may reside during runtime, and a secondary data storage 408, which may be non-volatile and stores machine readable instructions and data. The memory and data storage are examples of computer readable mediums. The memory 406 may include modules 420 including machine readable instructions residing in the memory 406 during runtime and executed by the processor 402. The modules 420 may include the modules 101, 105, 109, and 111-115 of the apparatus shown in FIG. 1.

The computer system may include an I/O device 410, such as a keyboard, a mouse, a display, etc. The computer system may include a network interface 412 for connecting to a network. Other known electronic components may be added or substituted in the computer system.

What has been described and illustrated herein is an example along with some of its variations. The terms, descriptions and figures used herein are set forth by way of illustration only and are not meant as limitations. Many variations are possible within the spirit and scope of the subject matter, which is intended to be defined by the following claims—and their equivalents—in which all terms are meant in their broadest reasonable sense unless otherwise indicated.

What is claimed is:

1. A method for virtual computing resource orchestration, the method comprising:
receiving environmental data related to an operational characteristic of a compute resource for hosting a virtual machine (VM);
receiving VM data related to an operational characteristic of the VM;
determining if the environmental data or the VM data violate predetermined threshold values respectively related to the environmental data and the VM data;
generating an event based on violation of one of the threshold values by the to environmental data or the VM data;
evaluating, by a processor, a rule to determine an action based on the violation of one of the threshold values; and
executing the action to modify the operational characteristic of the compute resource or the operational characteristic of the VM.

2. The method of claim 1, wherein the environmental data comprises:
power usage of the compute resource for hosting the VM.

3. The method of claim 1, wherein receiving VM data further comprises:
polling a virtualization system to obtain the VM data.

4. The method of claim 1, wherein the VM data comprises:
a state or an operational capacity of the VM.

5. The method of claim 1, further comprising:
receiving network data related to a volume of traffic on a network interconnected with the compute resource.

6. The method of claim 1, wherein executing the action to modify the operational characteristic of the compute resource comprises:
distributing a load on the compute resource between other compute resources.

7. The method of claim 1, wherein executing the action to modify the operational characteristic of the VM comprises:
starting, stopping, adding, or removing a VM.

8. The method of claim 1, wherein generating an event further comprises:
generating the event based on a plurality of violations of one of the threshold values by the environmental data or the VM data.

9. The method of claim 1, wherein generating an event further comprises:
generating the event based on a predetermined number of a plurality of violations of one of the threshold values by the environmental data or the VM data.

10. The method of claim 1, wherein generating an event further comprises:
generating the event based on:
an evaluation of the environmental data and the VM data within a predetermined time period, and
a plurality of violations of one of the threshold values by the environmental data or the VM data within the predetermined time period.

11. A virtual computing resource orchestration apparatus comprising:
a memory storing a module comprising machine readable instructions to:
receive environmental data related to an operational characteristic of a compute resource for hosting a virtual machine (VM);
receive VM data related to an operational characteristic of the VM;
determine if the environmental data or the VM data violate predetermined threshold values respectively related to the environmental data and the VM data;
generate an event based on violation of one of the threshold values by the environmental data or the VM data; and
evaluate a rule to determine an action based on the violation of one of the threshold values; and
a processor to implement the module.

12. The apparatus of claim 11, further comprising machine readable instructions to:
execute the action to modify the operational characteristic of the compute resource or the operational characteristic of the VM.

13. The apparatus of claim 11, wherein generating an event further comprises machine readable instructions to:
generate the event based on a plurality of violations of one of the threshold values by the environmental data or the VM data.

14. The apparatus of claim 11, wherein generating an event further comprises machine readable instructions to:
generate the event based on:
an evaluation of the environmental data and the VM data within a predetermined time period, and
a plurality of violations of one of the threshold values by the environmental data or the VM data within the predetermined time period.

15. A non-transitory computer readable medium having stored thereon machine readable instructions for virtual computing resource orchestration, the machine readable instructions when executed cause a computer system to:
receive environmental data related to an operational characteristic of a compute resource for hosting a virtual machine (VM);
receive VM data related to an operational characteristic of the VM;
determine if the environmental data or the VM data violate predetermined threshold values respectively related to the environmental data and the VM data;
generate an event based on a plurality of violations of one of the threshold values by the environmental data or the VM data; and
evaluate, by a processor, a rule to determine an action based on the plurality of violations of one of the threshold values.
